(19) United States
(12) Patent Application Publication
(10) Pub. No.: US 2023/0176572 A1
(43) Pub. Date: Jun. 8, 2023

(54) REMOTE OPERATION SYSTEM AND REMOTE OPERATION CONTROL METHOD

(71) Applicant: WOVEN PLANET HOLDINGS, INC., Tokyo (JP)

(72) Inventor: Yuki SUEHIRO, Ichikawa-shi (JP)

(73) Assignee: WOVEN PLANET HOLDINGS, INC., Tokyo (JP)

(21) Appl. No.: 17/970,877

(22) Filed: Oct. 21, 2022

(30) Foreign Application Priority Data
Dec. 3, 2021 (JP) 2021-196874

(51) Int. Cl. G05D 1/00; G06V 20/56; G06V 20/54

(52) U.S. Cl. CPC G05D 1/0038; G05D 1/0022; G05D 1/0055; G06V 20/56; G06V 20/54; G05D 2201/0213

(57) ABSTRACT

A remote operation system controls a remote operation of a moving body by a remote operator. A communication quality of communication performed by the moving body during the remote operation is acquired. When the communication quality is equal to or higher than a threshold, a first image captured by a first camera mounted on the moving body is presented to the remote operator. When the communication quality is lower than the threshold, the remote operation system switches an image to be presented to the remote operator. In the image switching process, a substitute camera installed on an object different from the moving body is used. Specifically, the remote operation system selects, as a second camera, a substitute camera capable of imaging at least the moving body and its surroundings, and presents a second image captured by the second camera to the remote operator.

### CROSS-REFERENCE TO RELATED APPLICATION

This application claims priority to Japanese Patent Application No. 2021-196874 filed on Dec. 3, 2021, the entire contents of which are incorporated by reference herein.

### BACKGROUND

### Technical Field

The present disclosure relates to a technique for controlling a remote operation of a moving body by a remote operator.

### Background Art

Patent Literature 1 discloses a remote driving device for remotely driving a vehicle. The remote driving device receives information of a current communication state of the vehicle from the vehicle. Then, the remote driving device displays the current communication state of the vehicle on a display device to inform a remote operator of the current communication state.

### LIST OF RELATED ART

Patent Literature 1: International Publication No. 2020/202379

### SUMMARY

A remote operation of a moving body (e.g., a vehicle, a robot) by a remote operator is considered. In the remote operation of the moving body, an image captured by a camera mounted on the moving body is transmitted to a remote operator terminal on the remote operator side. The remote operator terminal presents the received image to the remote operator, and the remote operator performs the remote operation of the moving body with viewing the image.

During the remote operation of the moving body, a communication quality of a communication performed by the moving body may be deteriorated. The deterioration of the communication quality causes trouble in the image transmission from the moving body to the remote operator terminal. If a communication blackout is caused, the image does not reach the remote operator terminal. In this manner, when the communication quality is deteriorated, it may be difficult for the remote operator to continue the remote operation of the moving body.

An object of the present disclosure is to provide a technique that enables a remote operator to continue a remote operation of a moving body as long as possible even when a communication quality of a communication performed by the moving body is deteriorated.

A first aspect is directed to a remote operation system that controls a remote operation of a moving body by a remote operator.

The remote operation system includes one or more processors.

The one or more processors are configured to execute:

a process of acquiring a communication quality of a communication performed by the moving body during the remote operation;

a process of presenting a first image captured by a first camera mounted on the moving body to the remote operator, when the communication quality is equal to or higher than a first threshold; and

an image switching process of switching an image to be presented to the remote operator, when the communication quality is lower than the first threshold.

The image switching process includes:

acquiring moving body information indicating a position and a direction of travel of the moving body;

acquiring substitute camera information indicating a position and a field of view of a substitute camera installed on an object different from the moving body;

selecting, based on the moving body information and the substitute camera information, a substitute camera capable of imaging at least the moving body and surroundings of the moving body, as a second camera; and

presenting a second image captured by the second camera to the remote operator.

A second aspect is directed to a remote operation control method for controlling a remote operation of a moving body by a remote operator.

The remote operation control method includes:

a process of acquiring a communication quality of a communication performed by the moving body during the remote operation;

a process of presenting a first image captured by a first camera mounted on the moving body to the remote operator, when the communication quality is equal to or higher than a first threshold; and

an image switching process of switching an image to be presented to the remote operator, when the communication quality is lower than the first threshold.

The image switching process includes:

acquiring moving body information indicating a position and a direction of travel of the moving body;

acquiring substitute camera information indicating a position and a field of view of a substitute camera installed on an object different from the moving body;

selecting, based on the moving body information and the substitute camera information, a substitute camera capable of imaging at least the moving body and surroundings of the moving body, as a second camera; and

presenting a second image captured by the second camera to the remote operator.

According to the present disclosure, the image switching process is performed as necessary in consideration of the communication quality of the communication performed by the moving body. More specifically, when the communication quality is lower than the first threshold, the second camera capable of imaging the moving body and its surroundings is selected instead of the first camera mounted on the moving body. Then, the second image captured by the second camera is presented to the remote operator as substitute for the first image. This enables the remote operator to continue the remote operation of the moving body.

### BRIEF DESCRIPTION OF DRAWINGS

FIG. 1 is a schematic diagram showing a configuration example of a remote operation system according to an embodiment of the present disclosure;

FIG. 2 is a conceptual diagram for explaining processing performed by the remote operation system when communication quality is normal according to an embodiment of the present disclosure;

FIG. 3 is a conceptual diagram for explaining processing performed by the remote operation system when communication quality is abnormal according to an embodiment of the present disclosure;

FIG. 4 is a block diagram showing an example of a functional configuration related to an image switching process according to an embodiment of the present disclosure;

FIG. 5 is a flow chart summarizing processing related to an image switching process according to an embodiment of the present disclosure;

FIG. 6 is a conceptual diagram for explaining an image switching process considering a camera priority according to an embodiment of the present disclosure;

FIG. 7 is a conceptual diagram for explaining an example of a camera priority according to an embodiment of the present disclosure;

FIG. 8 is a conceptual diagram for explaining another example of a camera priority according to an embodiment of the present disclosure;

FIG. 9 is a block diagram showing an example of a functional configuration related to an image switching process and an image transmission suppression process according to an embodiment of the present disclosure;

FIG. 10 is a conceptual diagram for explaining an example of an image transmission suppression process according to an embodiment of the present disclosure;

FIG. 11 is a block diagram showing an example of a functional configuration related to an image switching process and a travel restriction process according to an embodiment of the present disclosure;

FIG. 12 is a conceptual diagram for explaining an example of a travel restriction process according to an embodiment of the present disclosure;

FIG. 13 is a block diagram showing a configuration example of a vehicle according to an embodiment of the present disclosure;

FIG. 14 is a block diagram showing a configuration example of a remote operator terminal according to an embodiment of the present disclosure; and

FIG. 15 is a block diagram showing a configuration example of a management device according to an embodiment of the present disclosure.

### EMBODIMENTS

Embodiments of the present disclosure will be described with reference to the accompanying drawings.

### 1. Outline of Remote Operation System

A remote operation (remote driving) of a moving body is considered. Examples of the moving body being a target of the remote operation include a vehicle, a robot, a flying object, and the like. The vehicle may be an autonomous driving vehicle or may be a vehicle driven by a driver. Examples of the robot include a logistics robot, a work robot, and the like. Examples of the flying object include an airplane, a drone, and the like.

As an example, in the following description, a case where the moving body being the target of the remote operation is a vehicle will be considered. When generalizing, “vehicle” in the following description shall be deemed to be replaced with “moving body.”

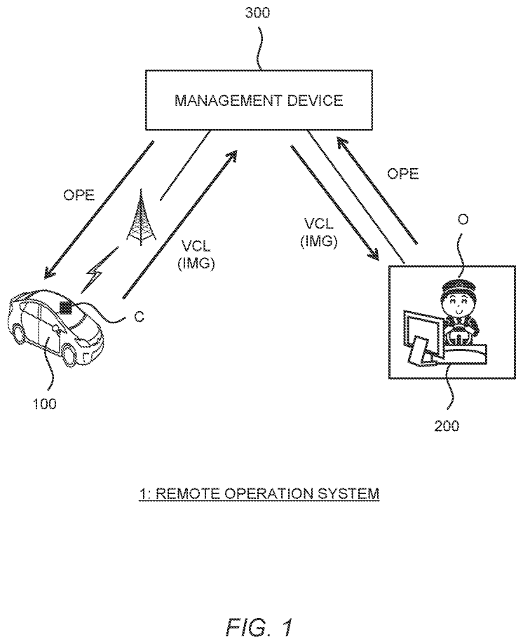

FIG. 1 is a schematic diagram showing a configuration example of a remote operation system 1 according to the present embodiment. The remote operation system 1 includes a vehicle 100, a remote operator terminal 200, and a management device 300. The vehicle 100 is the target of the remote operation. The remote operator terminal 200 is a terminal device used by a remote operator O when remotely operating the vehicle 100. The remote operator terminal 200 can also be referred to as a remote operation human machine interface (HMI). The management device 300 manages the remote operation system 1. The management of the remote operation system 1 includes, for example, assigning a remote operator O to a vehicle 100 that requires the remote operation. The management device 300 is able to communicate with the vehicle 100 and the remote operator terminal 200 via a communication network. Typically, the management device 300 is a management server on a cloud. The management server may be configured by a plurality of servers that perform distributed processing.

Various sensors including a camera C are mounted on the vehicle 100. The camera C images a situation around the vehicle 100 to acquire an image IMG indicating the situation around the vehicle 100. Vehicle information VCL is information acquired by the various sensors and includes the image IMG captured by the camera C. The vehicle 100 transmits the vehicle information VCL to the remote operator terminal 200 via the management device 300. That is, the vehicle 100 transmits the vehicle information VCL to the management device 300, and the management device 300 transfers the received vehicle information VCL to the remote operator terminal 200.

The remote operator terminal 200 receives the vehicle information VCL transmitted from the vehicle 100. The remote operator terminal 200 presents the vehicle information VCL to the remote operator O. More specifically, the remote operator terminal 200 includes a display device, and displays the image IMG and the like on the display device. The remote operator O views the displayed information to recognize the situation around the vehicle 100, and performs the remote operation of the vehicle 100. Remote operation information OPE is information regarding the remote operation by the remote operator O. For example, the remote operation information OPE includes an amount of operation performed by the remote operator O. The remote operator terminal 200 transmits the remote operation information OPE to the vehicle 100 via the management device 300. That is, the remote operator terminal 200 transmits the remote operation information OPE to the management device 300, and the management device 300 transfers the received remote operation information OPE to the vehicle 100.

The vehicle 100 receives the remote operation information OPE transmitted from the remote operator terminal 200. The vehicle 100 performs vehicle travel control in accordance with the received remote operation information OPE. In this manner, the remote operation of the vehicle 100 is realized.

### 2. Image Switching Process

### 2-1. Outline

A communication quality of the communication performed by the vehicle 100 during the remote operation. Examples of the communication quality include a communication speed (communication bandwidth), a communication delay, a round trip time (RTT), a received signal strength indicator (RSSI), and the like. The communication speed may be a throughput. In the real world, the communication quality varies depending on factors such as location, time, and environment.

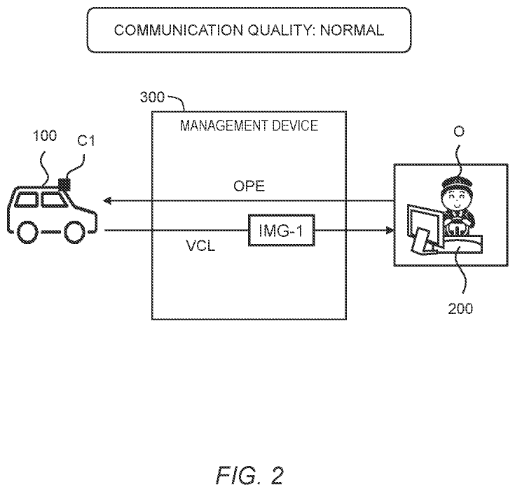

FIG. 2 is a conceptual diagram for explaining processing performed by the remote operation system 1 when the communication quality is normal. In the following description, for convenience sake, the camera C mounted on the vehicle 100 will be referred to as a a “first camera C1,” and the image IMG captured by the first camera C1 will be referred to as a “first image IMG-1.” The vehicle 100 transmits the vehicle information VCL including the first image IMG-1 captured by the first camera C1 to the remote operator terminals 200. When the communication quality is normal, the first image IMG-1 is normally transmitted to the remote operator terminal 200. The remote operator terminal 200 presents the first image IMG-1 received from the vehicle 100 to the remote operator O. The remote operator O is able to remotely operate the vehicle 100 with high accuracy by viewing the first image IMG-1.

Next, a case where the communication quality is abnormal will be considered. Here, “the communication quality being abnormal” means that “the communication quality is lower than a first threshold TH1.” For example, the first threshold TH1 is a low communication quality to such an extent that communication blackout is likely to occur. Such a decrease in the communication quality causes trouble in the transmission of the first image IMG-1 from the vehicle 100 to the remote operator terminal 200. If the communication blackout is caused, the first image IMG-1 does not reach the remote operator terminal 200. In this manner, when the communication quality is deteriorated, it may be difficult for the remote operator O to continue the remote operation of the vehicle 100. Such a technique is desired that enables the remote operator O to continue the remote operation of the vehicle 100 as long as possible even when the communication quality is deteriorated.

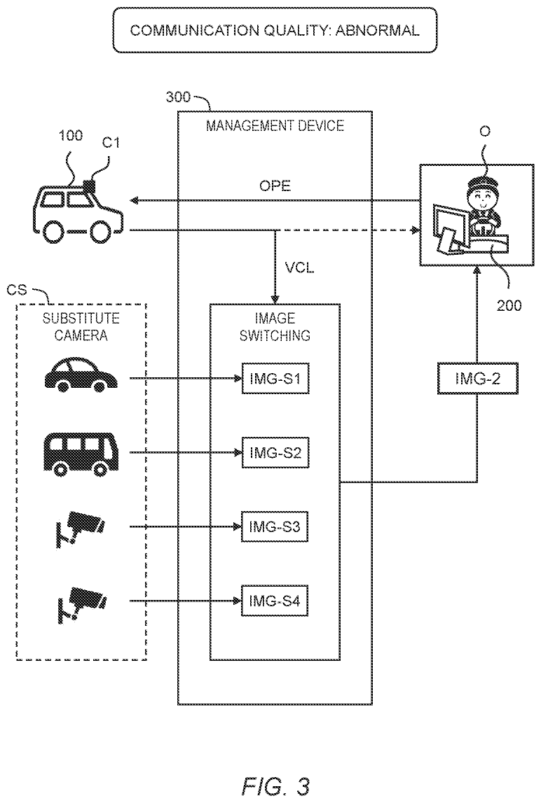

FIG. 3 is a conceptual diagram for explaining processing performed by the remote operation system 1 when the communication quality is abnormal. When the abnormality of the communication quality is detected, the remote operation system 1 according to the present embodiment switches the image IMG to be presented to the remote operator O to another one other than the first image IMG-1. This process is hereinafter referred to as an “image switching process.”

More specifically, a “substitute camera CS” is used in the image switching process. The substitute camera CS is a camera different from the first camera C1, and is installed on an object different from the vehicle 100 being the target of the remote operation. For example, the substitute camera CS is a camera mounted on another vehicle (e.g., a following vehicle) around the vehicle 100. As another example, the substitute camera CS may be a fixed camera (e.g., a surveillance camera, a network camera) installed on a stationary object. An image captured by the substitute camera CS is hereinafter referred to as a “substitute image IMG-S.” In the following description, each of one or more substitute cameras CS may be referred to as a “substitute camera CS-i” by the use of an index i (i is an integer equal to or greater than 1). A substitute image IMG-Si is the image captured by the substitute camera CS-i.

The management device 300 communicates with the substitute camera CS-i to receive the substitute image IMG-Si. In addition, the management device 300 acquires substitute camera information SUB-i indicating a position and a field of view of the substitute camera CS-i. In a case where the substitute camera CS-i is a fixed camera (e.g., a surveillance camera, a network camera), the substitute camera information SUB-i thereof is given as known information. In a case where the substitute camera CS-i is a camera mounted on another vehicle, the substitute camera information SUB-i thereof is obtained from said another vehicle. Furthermore, the management device 300 acquires the vehicle information VCL including at least a position and a direction of travel of the vehicle 100 from the vehicle 100.

Based on the vehicle information VCL and the substitute camera information SUB-i, the management device 300 selects a substitute camera CS-i capable of imaging at least the vehicle 100 and its surroundings as a “second camera C2.” The substitute image IMG-S captured by the selected second camera C2 is hereinafter referred to as a “second image IMG-2.” The second image IMG-2 may be on-view or top-view.

Then, the management device 300 transmits the second image IMG-2 instead of the first image IMG-1 to the remote operator terminal 200. The remote operator terminal 200 presents the second image IMG-2 to the remote operator O as substitute for the first image IMG-1. The remote operator O is able to continue the remote operation of the vehicle 100 to some extent by viewing the second image IMG-2. For example, the remote operator O is able to make the vehicle 100 stop safely by viewing the second image IMG-2. This is preferable from a viewpoint of ensuring safety of the remote operation.

### 2-2. Functional Configuration Example

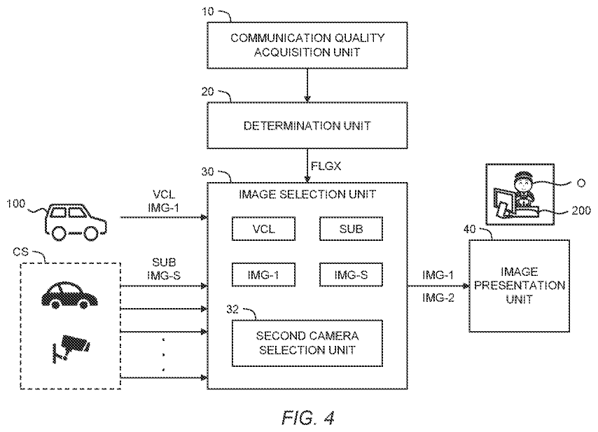

FIG. 4 is a block diagram showing an example of a functional configuration related to the image switching process according to the present embodiment. The remote operation system 1 includes a communication quality acquisition unit 10, a determination unit 20, an image selection unit 30, and an image presentation unit 40.

The communication quality acquisition unit 10 acquires the communication quality of the communication performed by the vehicle 100 at the time of the remote operation. The communication quality acquisition unit 10 may be included in the vehicle 100 or may be included in the management device 300 that is a communication partner of the vehicle 100. Examples of the communication quality include a communication speed, a communication delay, an RTT, an RSSI, and the like. The communication speed may be a throughput. For example, the communication quality acquisition unit 10 can measure the communication quality such as the communication speed, the communication delay, and the RSSI based on a reception state of data received from the communication partner. As another example, the communication quality acquisition unit 10 can measure the communication quality such as the communication speed, the communication delay, and the RTT based on data transmitted to the communication partner and feedback from the communication partner. Various methods for measuring or estimating the communication quality have been proposed, and the method is not particularly limited in the present embodiment.

The determination unit 20 receives information on the communication quality from the communication quality acquisition unit 10. The determination unit 20 may be included in the vehicle 100 or may be included in the management device 300. The determination unit 20 determines whether or not the communication quality is equal to or higher than the first threshold TH1. Then, the determination unit 20 outputs an image switching flag FLGX indicating the result of the determination. When the communication quality is lower than the first threshold TH1, the image switching flag FLGX indicates that the image switching process is necessary.

The image selection unit 30 is included in the management device 300. The image selection unit 30 receives the image switching flag FLGX from the determination unit 20. In addition, the image selection unit 30 receives the first image IMG-1 and the vehicle information VCL from the vehicle 100 that is the target of the remote operation. The vehicle information VCL includes at least the position and the direction of travel of the vehicle 100. Moreover, the image selection unit 30 receives the substitute image IMG-Si from the substitute camera CS-i. Furthermore, the image selection unit 30 acquires the substitute camera information SUB-i indicating the position and the field of view of the substitute camera CS-i. In a case where the substitute camera CS-i is a fixed camera, the substitute camera information SUB-i thereof is given as known information. In a case where the substitute camera CS-i is a camera mounted on another vehicle, the substitute camera information SUB-i thereof is obtained from said another vehicle.

When the image switching flag FLGX indicates that the communication quality is equal to or higher than the first threshold TH1, that is, the image switching process is not necessary, the image selection unit 30 selects the first image IMG-1. The image selection unit 30 outputs the selected first image IMG-1 to the image presentation unit 40.

On the other hand, when the image switching flag FLGX indicates that the communication quality is lower than the first threshold TH1, that is, the image switching process is necessary, the image selection unit 30 selects the second camera C2.

More specifically, the image selection unit 30 includes a second camera selection unit 32. The second camera selection unit 32 selects, based on the vehicle information VCL and the substitute camera information SUB-i, a substitute camera CS-i capable of imaging at least the vehicle 100 and the surroundings thereof as the second camera C2. A plurality of second cameras C2 may be selected. When selecting the second camera C2, priority depending on a situation in which the vehicle 100 is placed may be taken into consideration (see Section 3 described later).

The image selection unit 30 selects the substitute image IMG-S captured by the selected second camera C2 as the second image IMG-2. Then, the image selection unit 30 outputs the selected second image IMG-2 to the image presentation unit 40.

The image presentation unit 40 is included in the remote operator terminal 200. The image presentation unit 40 receives the first image IMG-1 or the second image IMG-2 selected by the image selection unit 30. Then, the image presentation unit 40 presents the received first image IMG-1 or the received second image IMG-2 to the remote operator O.

### 2-3. Process Flow

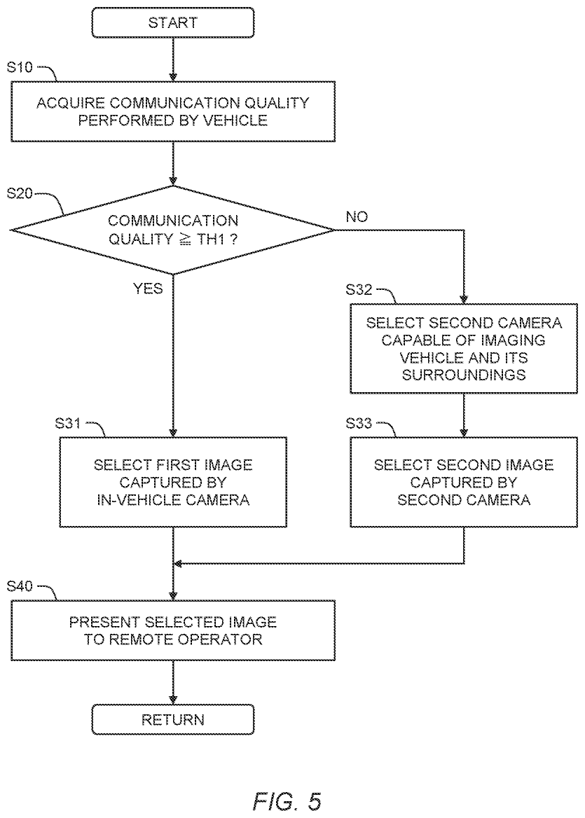

FIG. 5 is a flow chart summarizing the processing related to the image switching process according to the present embodiment.

In Step S10, the remote operation system 1 acquires the communication quality of the communication performed by the vehicle 100 during the remote operation.

In Step S20, the remote operation system 1 determines whether or not the communication quality is equal to or higher than the first threshold TH1. When the communication quality is equal to or higher than the first threshold TH1 (Step S20; Yes), the processing proceeds to Step S31. On the other hand, when the communication quality is lower than the first threshold TH1 (Step S20; No), the processing proceeds to Step S32.

In Step S31, the remote operation system 1 selects the first image IMG-1 captured by the first camera C1 mounted on the vehicle 100 that is the target of the remote operation. After that, the processing proceeds to Step S40.

In Step S32, the remote operation system 1 selects, as the second camera C2, a substitute camera CS-i capable of imaging at least the vehicle 100 and the surroundings thereof, based on the vehicle information VCL and the substitute camera information SUB-i.

In Step S33, the remote operation system 1 selects the substitute image IMG-S captured by the second camera C2 as the second image IMG-2.

In Step S40, the remote operation system 1 presents the first image IMG-1 or the second image IMG-2 selected to the remote operator O.

### 2-4. Effects

According to the present embodiment, as described above, the image switching process is performed as necessary in consideration of the communication quality of the communication performed by the vehicle 100. More specifically, when the communication quality is lower than the first threshold TH1, the second camera C2 capable of imaging the vehicle 100 and its surroundings is selected instead of the first camera C1 mounted on the vehicle 100. Then, the second image IMG-2 captured by the second camera C2 is presented to the remote operator O as substitute for the first image IMG-1. This enables the remote operator O to continue the remote operation of the vehicle 100. For example, the remote operator O is able to make the vehicle 100 stop safely by viewing the second image IMG-2. This is preferable from a viewpoint of ensuring safety of the remote operation.

### 3. Image Switching Process Considering Camera Priority

There may be a plurality of candidates for the second camera C2. In that case, the second camera C2 may be selected from the plurality of candidates in consideration of a camera priority.

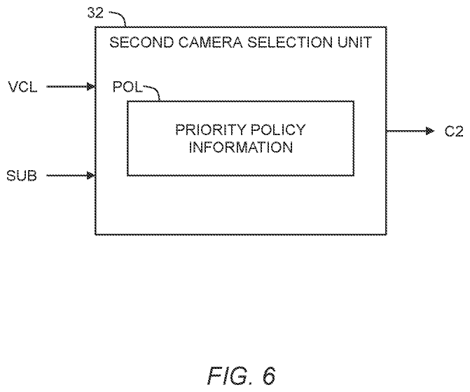

FIG. 6 is a conceptual diagram for explaining the image switching process in consideration of the camera priority. The second camera selection unit 32 holds priority policy information POL indicating a setting policy of a priority of the second camera C2. When there are a plurality of candidates for the second camera C2, the second camera selection unit 32 selects the second camera C2 from the plurality of candidates according to the priority based on the priority policy information POL.

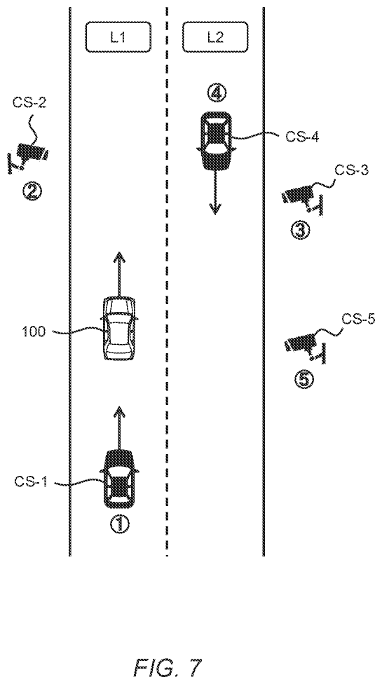

FIG. 7 is a conceptual diagram for explaining an example of the camera priority. The vehicle 100 being the target of the remote operation is present in a travel lane L1. A substitute camera CS-1 is a moving camera (a following camera) mounted on a following vehicle traveling behind the vehicle 100. A substitute camera CS-2 is a fixed camera installed on a roadside of the travel lane L1 in front of the vehicle 100. A substitute camera CS-3 is a fixed camera installed on a roadside of an oncoming lane L2 in front of the vehicle 100. A substitute camera CS-4 is a moving camera mounted on an oncoming vehicle traveling in the oncoming lane L2. A substitute camera CS-5 is a fixed camera installed on the roadside of the oncoming lane L2 behind the vehicle 100.

In the example shown in FIG. 7, the priority is higher in an order of the substitute cameras CS-1, CS-2, CS-3, CS-4, and CS-5. That is, the substitute camera CS-1 (i.e., the following camera) mounted on the following vehicle has the highest priority. The priority of the substitute camera CS-1 (i.e., the following camera) is higher than the priority of each of the substitute cameras CS-2, CS-3, and CS-5 which are the fixed cameras around the vehicle 100. The reason is that a field of view similar to that of the first camera C1 mounted on the vehicle 100 can be obtained in the case of the substitute camera CS-1 (i.e., the following camera).

When comparing the travel lane L1 and the oncoming lane L2, the priority on the side of the travel lane L1 is higher than the priority on the side of the oncoming lane L2. For example, the priority of the substitute camera CS-2 installed on the roadside of the travel lane L1 is higher than the priority of each of the substitute cameras CS-3 and CS-5 installed on the roadside of the oncoming lane L2. The reason is that the substitute image IMG-S captured by the substitute camera CS on the side of the travel lane L1 represents the situation of the vehicle 100 and its surroundings in more detail.

When comparing the front and rear sides of the vehicle 100, the priority of the front side is higher than the priority of the rear side. For example, the priority of each of the substitute cameras CS-3 and CS-4 on the front side is higher than the priority of the substitute camera CS-5 on the rear side. The reason is that the substitute image IMG-S of the front side of the vehicle 100 is more useful in the remote operation of the vehicle 100.

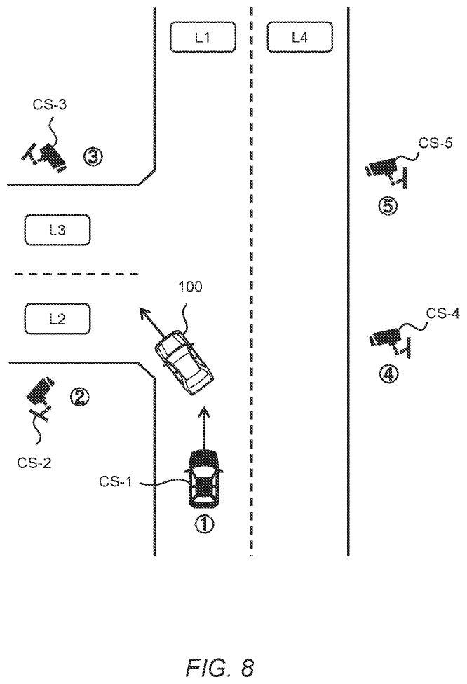

FIG. 8 is a conceptual diagram for explaining another example of the camera priority. The vehicle 100 being the target of the remote operation makes a left turn at an intersection and moves from a travel lane L1 to a travel lane L2. A substitute camera CS-1 is a moving camera (a following camera) mounted on a following vehicle traveling behind the vehicle 100. A substitute camera CS-2 is a fixed camera installed on a roadside of the travel lane L2 in front of the vehicle 100. A substitute camera CS-3 is a fixed camera installed on a roadside of an oncoming lane L3 in front of the vehicle 100. Substitute cameras CS-4 and CS-5 are fixed cameras installed on a roadside of an oncoming lane L4 behind the vehicle 100.

In the example shown in FIG. 8, the priority is higher in an order of the substitute cameras CS-1, CS-2, CS-3, CS-4, and CS-5. That is, the substitute camera CS-1 (i.e., the following camera) mounted on the following vehicle has the highest priority. The priority of the substitute camera CS-1 (i.e., the following camera) is higher than the priority of each of the substitute cameras CS-2 to CS-5 which are the fixed cameras around the vehicle 100.

When the vehicle 100 makes a left turn, the priority of each of the substitute cameras CS-2 and CS-3 present on the left side as viewed from the vehicle 100 is higher than the priority of each of the substitute cameras CS-4 and CS-5 present on the right side as viewed from the vehicle 100. The reason is that the substitute image IMG on the side of the direction of travel of the vehicle 100 is more useful in the remote operation of the vehicle 100.

This can be generalized as follows. The vehicle 100 turns to a first direction. The plurality of candidates for the second camera C2 include a first substitute camera present on a side of the first direction when viewed from the vehicle 100 and a second substitute camera present on a side of a second direction opposite to the first direction when viewed from the vehicle 100. In this case, the priority of the first substitute camera is higher than the priority of the second substitute camera.

As described above, the vehicle information VCL indicates the position and the direction of travel of the vehicle 100. The substitute camera information SUB-i indicates the position and the field of view of the substitute camera CS-i. Further, the second camera selection unit 32 holds map information. Thus, the second camera selection unit 32 is able to grasp a positional relationship between the vehicle 100 and the substitute camera CS-i and a behavior of the vehicle 100 based on the map information, the vehicle information VCL, and the substitute camera information SUB-i. The priority policy information POL gives the priority setting that depends on the positional relationship and the behavior. Based on the positional relationship, the behavior, and the priority policy information POL, the second camera selection unit 32 is able to acquire the priority of the plurality of candidates for the second camera C2. Then, the second camera selection unit 32 selects the second camera C2 from the plurality of candidates in accordance with the priority. Multiple second cameras C2 may be selected in the order of the priority.

As described above, the priority of the candidates for the second camera C2 is determined by the positional relationship between the vehicle 100 and the substitute camera CS-i and the behavior of the vehicle 100. Taking such the priority into consideration makes it possible to select the second camera C2 suitable for the situation in which the vehicle 100 is placed. As a result, accuracy of the remote operation using the second image IMG-2 captured by the second camera C2 is improved.

### 4. Image Transmission Suppression Process

In the case where the communication quality is deteriorated, the transmission of the first image IMG-1 from the vehicle 100 may be suppressed to reduce the amount of transmission data and to continue the communication as possible. Such the process is hereinafter referred to as an “image transmission suppression process.”

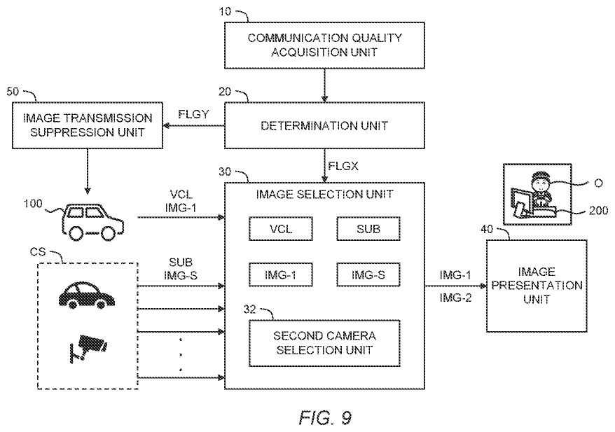

FIG. 9 is a block diagram showing an example of a functional configuration related to the image switching process and the image transmission suppression process according to the present embodiment. The remote operation system 1 further includes an image transmission suppression unit 50 in addition to the above-described functional blocks. The image transmission suppression unit 50 is included in the vehicle 100 and performs the image transmission suppression process as necessary.

More specifically, the determination unit 20 determines whether or not the image transmission suppression process is necessary based on the communication quality. The determination unit 20 outputs an image transmission suppression flag FLGY indicating the result of the determination. The image transmission suppression unit 50 receives the image transmission suppression flag FLGY, and decides whether or not to perform the image transmission suppression process based on the content of the image transmission suppression flag FLGY.

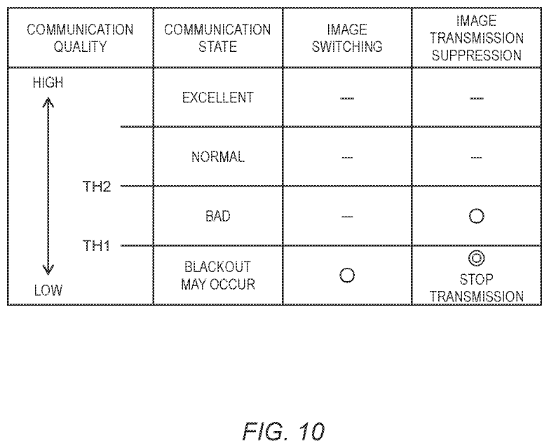

FIG. 10 is a conceptual diagram for explaining an example of the image transmission suppression process. A second threshold TH2 regarding the communication quality is higher than the first threshold TH1 (TH2>TH1). When the communication quality is equal to or higher than the second threshold TH2, the communication state is excellent or normal, and thus the determination unit 20 determines that the image transmission suppression process is unnecessary.

On the other hand, when the communication quality is lower than the second threshold TH2, the communication state is bad, and thus the determination unit 20 determines that the image transmission suppression process is necessary. In this case, the image transmission suppression unit 50 performs the image transmission suppression process, that is, suppresses the transmission of the first image IMG-1 from the vehicle 100. For example, the image transmission suppression unit 50 sets a resolution (the number of pixels) of the first image IMG-1 to a value lower than a default value. For example, when the resolution decreases from 1080p to 360p, the amount of transmission data becomes about 1/9. As another example, in a case where a plurality of first cameras C1 are mounted on the vehicle 100, the image transmission suppression unit 50 may selectively transmit only the first image IMG-1 captured by a part of the first cameras C1 (e.g., a front camera).

When the communication quality is lower than the first threshold TH1, the “image switching process” described above is performed. When the image switching process is performed, the image transmission suppression unit 50 may stop the transmission of the first image IMG-1 from the vehicle 100, because the first image IMG-1 is not selected. That is, the image transmission suppression unit 50 may stop the transmission of the first image IMG-1 from the vehicle 100 in conjunction with the image switching process.

As described above, when the communication quality is deteriorated, the transmission of the first image IMG-1 from the vehicle 100 is suppressed. This makes it possible to reduce the amount of transmission data and to secure communication of important information as much as possible. For example, it is possible to secure transmission of the vehicle information VCL other than the first image IMG-1 as much as possible. In addition, it is possible to secure transmission of the remote operation information OPE from the remote operator terminal 200 to the vehicle 100 as much as possible.

### 5. Travel Restriction Process

When the image switching process is performed, the remote operator O performs the remote operation by viewing the second image IMG-2 instead of the original first image IMG-1. At this time, it is preferable to restrict (limit) travel of the vehicle 100 from a viewpoint of safety of the remote operation. Restricting (limiting) the travel of the vehicle 100 means setting an upper limit value of a travel parameter of the vehicle 100 to be lower than a default value. The travel parameter includes at least one of a vehicle speed, a steering angle, and a steering speed. Such the process of restricting the travel of the vehicle 100 is hereinafter referred to as a “travel restriction process.”

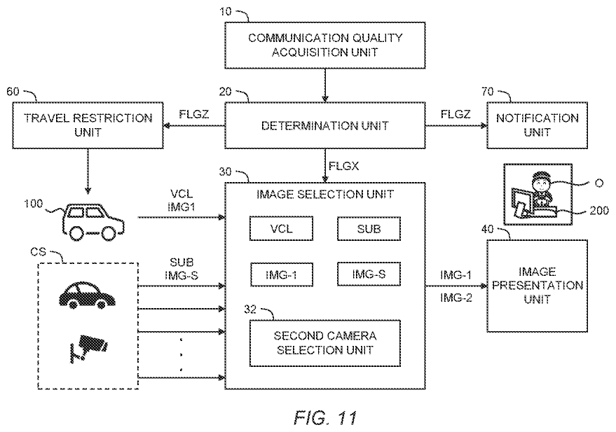

FIG. 11 is a block diagram showing an example of a functional configuration related to the image switching process and the travel restriction process according to the present embodiment. The remote operation system 1 further includes a travel restriction unit 60 in addition to the above-described functional blocks. The travel restriction unit 60 may be included in any of the vehicle 100, the remote operator terminal 200, and the management device 300. The travel restriction unit 60 performs the travel restriction process as necessary.

More specifically, the determination unit 20 determines whether or not the travel restriction process is necessary based on the communication quality. The determination unit 20 outputs a travel restriction flag FLGZ indicating the result of the determination. The travel restriction unit 60 receives the travel restriction flag FLGZ, and decides whether or not to perform the travel restriction process based on the content of the travel restriction flag FLGZ.

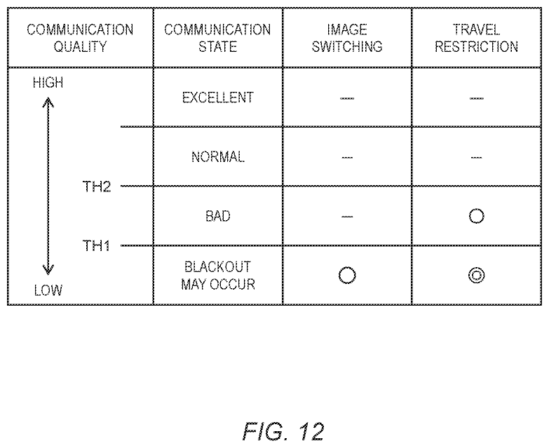

FIG. 12 is a conceptual diagram for explaining an example of the travel restriction process. When the communication quality is lower than the first threshold TH1, the “image switching process” described above is performed. At least when the image switching process is performed, the determination unit 20 determines that the travel restriction process is necessary. In this case, the travel restriction unit 60 performs the travel restriction process. That is, the travel restriction unit 60 executes the travel restriction process in conjunction with the image switching process.

In the travel restriction process, the travel restriction unit 60 sets an upper limit value of the operation amount for operating the vehicle 100 to be lower than a default value. The travel restriction unit 60 receives the remote operation information OPE including the operation amount of the operation performed by the remote operator O. When the operation amount included in the remote operation information OPE exceeds the upper limit value, the travel restriction unit 60 restricts (corrects) the operation amount to the upper limit value or less. Then, the travel restriction unit 60 outputs the remote operation information OPE in which the operation amount is restricted. The vehicle 100 performs the vehicle travel control in accordance with the remote operation information OPE in which the operation amount is restricted. Thus, the travel of the vehicle 100 is restricted. As a result, the safety of the remote operation of the vehicle 100 is secured.

As described above, “restricting the operation amount for operating the vehicle 100” is equivalent to “restricting the travel of the vehicle 100.” Further, “setting the upper limit value of the operation amount for operating the vehicle 100 to be lower than a default value” is equivalent to “setting the upper limit value of the travel parameter (e.g., the vehicle speed, the steering angle, the steering speed) of the vehicle 100 to be lower than a default value.” It can be said that the travel restriction unit 60 performs the travel restriction process through the operation amount.

Also when the communication quality is lower than the second threshold TH2, the determination unit 20 may determine that the travel restriction process is necessary. It is also possible to tighten the restriction as the communication quality becomes lower. Tightening the restriction means decreasing the upper limit value of the operation amount (i.e., the travel parameter) further. As the communication quality becomes lower, the upper limit value decreases (i.e., the restriction is tightened) and thus the safety of the remote operation of the vehicle 100 is more appropriately secured.

When the communication quality is equal to or higher than the second threshold TH2, the determination unit 20 determines that the travel restriction process is unnecessary.

As shown in FIG. 11, the remote operation system 1 may further include a notification unit 70. The notification unit 70 is included in the remote operator terminal 200. The notification unit 70 receives the travel restriction flag FLGZ. While the travel restriction process is in execution, the notification unit 70 notifies the remote operator O of the fact that the travel of the vehicle 100 is restricted. The notification may be performed visually or audibly. For example, the notification unit 70 displays a notification (e.g., “vehicle speed is limited: upper limit speed=** km/h”) on a display device. As another example, the notification unit 70 outputs an audio notification through a speaker. As a result, it is possible to prevent the remote operator O from feeling a sense of strangeness about the travel restriction process.

It should be noted that it is also possible to combine the image transmission suppression process described in Section 4 and the travel restriction process described in Section 5.

### 6. Example of Vehicle

### 6-1. Configuration Example

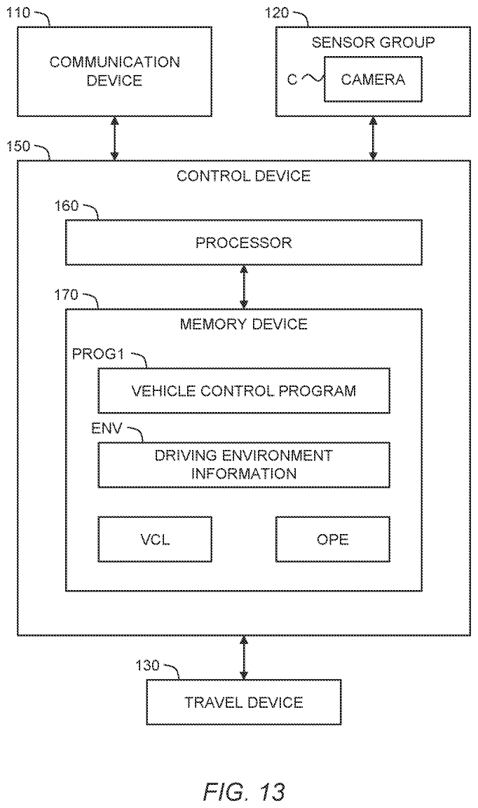

FIG. 13 is a block diagram showing a configuration example of the vehicle 100. The vehicle 100 includes a communication device 110, a sensor group 120, a travel device 130, and a control device (controller) 150.

The communication device 110 communicates with the outside of the vehicle 10. For example, the communication device 110 communicates with the remote operator terminal 200 and the management device 300.

The sensor group 120 includes a recognition sensor, a vehicle state sensor, a position sensor, and the like. The recognition sensor recognizes (detects) a situation around the vehicle 100. Examples of the recognition sensor include the camera C, a LIDAR (Laser Imaging Detection and Ranging), a radar, and the like. The vehicle state sensor detects a state of the vehicle 100. Examples of the vehicle state sensor include a speed sensor, an acceleration sensor, a yaw rate sensor, a steering angle sensor, and the like. The position sensor detects a position and an orientation of the vehicle 10. For example, the position sensor includes a GNSS (Global Navigation Satellite System).

The travel device 130 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device 150 is a computer that controls the vehicle 10. The control device 150 includes one or more processors 160 (hereinafter simply referred to as a processor 160) and one or more memory devices 170 (hereinafter simply referred to as a memory device 170). The processor 160 executes a variety of processing. For example, the processor 160 includes a CPU (Central Processing Unit). The memory device 170 stores a variety of information necessary for the processing by the processor 160. Examples of the memory device 170 include a volatile memory, a non-volatile memory, an HDD (Hard Disk Drive), an SSD (Solid State Drive), and the like. The control device 150 may include one or more ECUs (Electronic Control Units).

A vehicle control program PROG1 is a computer program executed by the processor 160. The functions of the control device 150 are implemented by the processor 160 executing the vehicle control program PROG1. The vehicle control program PROG1 is stored in the memory device 170. The vehicle control program PROG1 may be recorded on a non-transitory computer-readable recording medium.

### 6-2. Driving Environment Information

The control device 150 uses the sensor group 120 to acquire driving environment information ENV indicating a driving environment for the vehicle 100. The driving environment information ENV is stored in the memory device 170.

The driving environment information ENV includes surrounding situation information indicating a result of recognition by the recognition sensor. For example, the surrounding situation information includes the image IMG captured by the camera C. The surrounding situation information further includes object information regarding an object around the vehicle 10. Examples of the object around the vehicle 100 include a pedestrian, another vehicle (e.g., a preceding vehicle, a parked vehicle, etc.), a white line, a traffic signal, a sign, a roadside structure, and the like. The object information indicates a relative position and a relative velocity of the object with respect to the vehicle 10.

In addition, the driving environment information ENV includes vehicle state information indicating the vehicle state detected by the vehicle state sensor.

Furthermore, the driving environment information ENV includes vehicle position information indicating the position and the orientation of the vehicle 100. The vehicle position information is acquired by the position sensor. Highly accurate vehicle position information may be acquired by performing a well-known localization using map information and the surrounding situation information (the object information).

### 6-3. Vehicle Travel Control

The control device 150 executes vehicle travel control that controls travel of the vehicle 100. The vehicle travel control includes steering control, driving control, and braking control. The control device 150 executes the vehicle travel control by controlling the travel device 130 (i.e., the steering device, the driving device, and the braking device).

The control device 150 may execute autonomous driving control based on the driving environment information ENV. More specifically, the control device 150 generates a travel plan of the vehicle 100 based on the driving environment information ENV. Further, the control device 150 generates, based on the driving environment information ENV, a target trajectory required for the vehicle 100 to travel in accordance with the travel plan. The target trajectory includes a target position and a target speed. Then, the control device 150 executes the vehicle travel control such that the vehicle 100 follows the target trajectory.

### 6-4. Processing Related to Remote Operation

Hereinafter, the case where the remote operation of the vehicle 100 is performed will be described. The control device 150 communicates with the remote operator terminal 200 via the communication device 110.

The control device 150 transmits the vehicle information VCL to the remote operator terminal 200. The vehicle information VCL is information necessary for the remote operation by the remote operator O, and includes at least a part of the driving environment information ENV described above. For example, the vehicle information VCL includes the surrounding situation information (especially, the image IMG). The vehicle information VCL may further include the vehicle state information and the vehicle position information.

In addition, the control device 150 receives the remote operation information OPE from the remote operator terminal 200. The remote operation information OPE is information regarding the remote operation by the remote operator O. For example, the remote operation information OPE includes an amount of operation performed by the remote operator O. The control device 150 performs the vehicle travel control in accordance with the received remote operation information OPE.

Furthermore, the control device 150 may have the functions of the communication quality acquisition unit 10 and the determination unit 20 described above. In this case, the control device 150 transmits flag information (FLGX, FLGY, and FLGZ) indicating results of determination by the determination unit 20 to the remote operator terminal 200 or the management device 300 as necessary.

Moreover, the control device 150 may have the function of the image transmission suppression unit 50 described above. The control device 150 performs the image transmission suppression process based on the image transmission suppression flag FLGY.

Furthermore, the control device 150 may have the function of the travel restriction unit 60 described above. The control device 150 acquires the remote operation information OPE received from the remote operator terminal 200. Then, the control device 150 restricts the operation amount based on the travel restriction flag FLGZ and the remote operation information OPE.

### 7. Example of Remote Operator Terminal

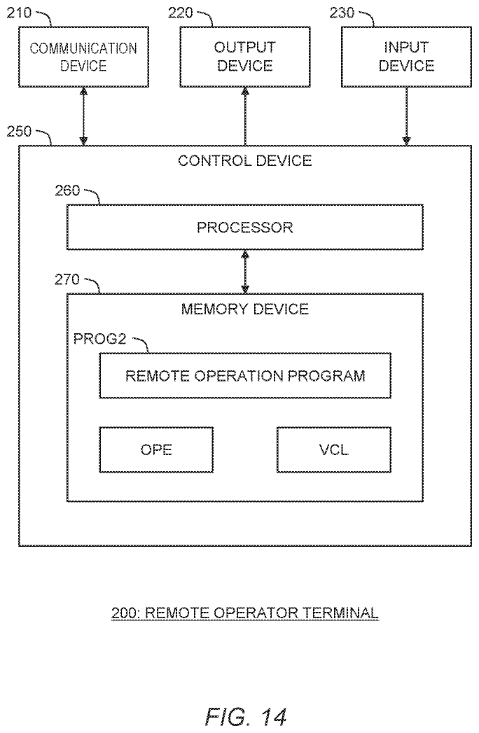

FIG. 14 is a block diagram showing a configuration example of the remote operator terminal 200. The remote operator terminal 200 includes a communication device 210, an output device 220, an input device 230, and a control device (controller) 250.

The communication device 210 communicates with the vehicle 100 and the management device 300.

The output device 220 outputs a variety of information. For example, the output device 220 includes a display device. The display device presents a variety of information to the remote operator O by displaying the variety of information. As another example, the output device 220 may include a speaker. The output device 220 includes the functions of the image presentation unit 40 and the notification unit 70.

The input device 230 receives an input from the remote operator O. For example, the input device 230 includes a remote operation member that is operated by the remote operator O when remotely operating the vehicle 100. The remote operation member includes a steering wheel, an accelerator pedal, a brake pedal, a direction indicator, and the like.

The control device 250 controls the remote operator terminal 200. The control device 250 includes one or more processors 260 (hereinafter simply referred to as a processor 260) and one or more memory devices 270 (hereinafter simply referred to as a memory device 270). The processor 260 executes a variety of processing. For example, the processor 260 includes a CPU. The memory device 270 stores a variety of information necessary for the processing by the processor 260. Examples of the memory device 270 include a volatile memory, a non-volatile memory, an HDD, an SSD, and the like.

A remote operation program PROG2 is a computer program executed by the processor 260. The functions of the control device 250 are implemented by the processor 260 executing the remote operation program PROG2. The remote operation program PROG2 is stored in the memory device 270. The remote operation program PROG2 may be recorded on a non-transitory computer-readable recording medium. The remote operation program PROG2 may be provided via a network.

The control device 250 communicates with the vehicle 100 via the communication device 210. The control device 250 receives the vehicle information VCL transmitted from the vehicle 100. The control device 250 presents the vehicle information VCL to the remote operator O by displaying the vehicle information VCL including the image information on the display device. The remote operator O is able to recognize the state of the vehicle 100 and the situation around the vehicle 100 based on the vehicle information VCL displayed on the display device.

The remote operator O operates the remote operation member of the input device 230. An operation amount of the remote operation member is detected by a sensor installed on the remote operation member. The control device 250 generates the remote operation information OPE reflecting the operation amount of the remote operation member operated by the remote operator O. Then, the control device 250 transmits the remote operation information OPE to the vehicle 100 via the communication device 210.

Furthermore, the control device 250 may have the function of the travel restriction unit 60 described above. The control device 250 restricts the operation amount based on the travel restriction flag FLGZ and the remote operation information OPE. Then, the control device 250 transmits the remote operation information OPE in which the operation amount is restricted to the vehicle 100.

### 8. Example of Management Device

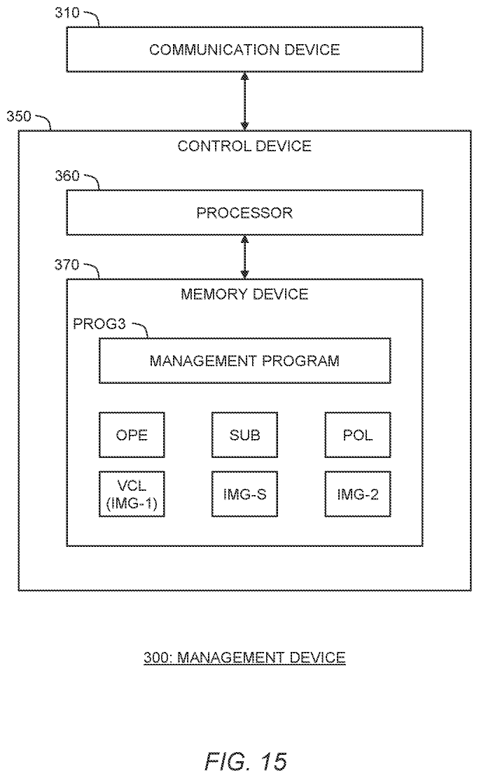

FIG. 15 is a block diagram showing a configuration example of the management device 300. The management device 300 includes a communication device 310 and a control device 350.

The communication device 310 communicates with the vehicle 100 and the remote operator terminal 200.

The control device (controller) 350 controls the management device 300. The control device 350 includes one or more processors 360 (hereinafter simply referred to as a processor 360) and one or more memory devices 370 (hereinafter simply referred to as a memory device 370). The processor 360 executes a variety of processing. For example, the processor 360 includes a CPU. The memory device 370 stores a variety of information necessary for the processing by the processor 360. Examples of the memory device 370 include a volatile memory, a non-volatile memory, an HDD, an SSD, and the like.

A management program PROG3 is a computer program executed by the processor 360. The functions of the control device 350 are implemented by the processor 360 executing the management program PROG3. The management program PROG3 is stored in the memory device 370. The management program PROG3 may be recorded on a non-transitory computer-readable recording medium. The management program PROG3 may be provided via a network.

The control device 350 communicates with the vehicle 100 and the remote operator terminal 200 via the communication device 310. The control device 350 receives the vehicle information VCL transmitted from the vehicle 100. Then, the control device 350 transmits the received vehicle information VCL to the remote operator terminal 200. In addition, the control device 350 receives the remote operation information OPE transmitted from the remote operator terminal 200. Then, the control device 350 transmits the received remote operation information OPE to the vehicle 100.

Furthermore, the control device 350 may have the functions of the communication quality acquisition unit 10 and the determination unit 20 described above. In this case, the control device 350 transmits flag information (FLGX, FLGY, and FLGZ) indicating results of determination by the determination unit 20 to the vehicle 100 or the remote operator terminal 200 as necessary.

Moreover, the control device 350 has the function of the image selection unit 30 described above. The control device 350 communicates with the vehicle 100 and the substitute camera CS to receive necessary information. The control device 350 selects the first image IMG-1 or the second image IMG-2 based on the image switching flag FLGX. Then, the control device 350 transmits the selected first image IMG-1 or second image IMG-2 to the remote operator terminal 200.

Furthermore, the control device 350 may have the function of the travel restriction unit 60 described above. The control device 350 acquires the remote operation information OPE received from the remote operator terminal 200. Further, the control device 350 restricts the operation amount based on the travel restriction flag FLGZ and the remote operation information OPE. Then, the control device 350 transmits the remote operation information OPE in which the operation amount is restricted to the vehicle 100.

What is claimed is:

1. A remote operation system that controls a remote operation of a moving body by a remote operator,
the remote operation system comprising one or more processors configured to execute:
a process of acquiring a communication quality of a communication performed by the moving body during the remote operation;
a process of presenting a first image captured by a first camera mounted on the moving body to the remote operator, when the communication quality is equal to or higher than a first threshold; and
an image switching process of switching an image to be presented to the remote operator, when the communication quality is lower than the first threshold, wherein
the image switching process includes:
acquiring moving body information indicating a position and a direction of travel of the moving body;
acquiring substitute camera information indicating a position and a field of view of a substitute camera installed on an object different from the moving body;
selecting, based on the moving body information and the substitute camera information, a substitute camera capable of imaging at least the moving body and surroundings of the moving body, as a second camera; and
presenting a second image captured by the second camera to the remote operator.

2. The remote operation system according to claim 1, wherein
the one or more processors are further configured to stop transmission of the first image from the moving body when the communication quality is lower than the first threshold.

3. The remote operation system according to claim 1, further comprising one or more memory devices configured to store priority policy information indicating a setting policy of a priority of the second camera, wherein
when there are a plurality of candidates for the second camera, the one or more processors select the second camera from the plurality of candidates according to the priority based on the priority policy information.

4. The remote operation system according to claim 3, wherein
when the plurality of candidates for the second camera include a following camera mounted on a following moving body that travels behind the moving body, the priority of the following camera is higher than the priority of every other substitute cameras.

5. The remote operation system according to claim 3, wherein
when the moving body turns to a first direction, and the plurality of candidates for the second camera include a first substitute camera present on a side of the first direction when viewed from the moving body and a second substitute camera present on a side of a second direction opposite to the first direction when viewed from the moving body, the priority of the first substitute camera is higher than the priority of the second substitute camera.

6. The remote operation system according to claim 3, wherein
when the plurality of candidates for the second camera include a first fixed camera installed on a side of a travel lane of the moving body and a second fixed camera installed on a side of an oncoming lane, the priority of the first fixed camera is higher than the priority of the second fixed camera.

7. The remote operation system according to claim 1, wherein
the one or more processors are further configured to execute a travel restriction process of restricting travel of the moving body in conjunction with the image switching process.

8. The remote operation system according to claim 7, wherein
when the travel restriction process is in execution, the one or more processors notify the remote operator of a fact that the travel of the moving body is restricted.

9. A remote operation control method for controlling a remote operation of a moving body by a remote operator,
the remote operation control method comprising:
a process of acquiring a communication quality of a communication performed by the moving body during the remote operation;
a process of presenting a first image captured by a first camera mounted on the moving body to the remote operator, when the communication quality is equal to or higher than a first threshold; and
an image switching process of switching an image to be presented to the remote operator, when the communication quality is lower than the first threshold, wherein
the image switching process includes:
acquiring moving body information indicating a position and a direction of travel of the moving body;
acquiring substitute camera information indicating a position and a field of view of a substitute camera installed on an object different from the moving body;
selecting, based on the moving body information and the substitute camera information, a substitute camera capable of imaging at least the moving body and surroundings of the moving body, as a second camera; and
presenting a second image captured by the second camera to the remote operator.
